(19) United States
(12) Patent Application Publication
(10) Pub. No.: US 2012/0270454 A1
(43) Pub. Date: Oct. 25, 2012

(54) BODY ARMOR ARTICLE AND METHOD OF MAKING

(75) Inventors: Minshon J. Chiou, Chesterfield, VA (US); Gerald Oronde Brown, Wilmington, DE (US); Teresa C. Madeleine, Wilmington, DE (US)

(73) Assignee: E.I. DU PONT DE NEMOURS AND COMPANY, Wilmington, DE (US)

(21) Appl. No.: 13/091,228

(22) Filed: Apr. 21, 2011

(51) Int. Cl. B32B 27/04; B05D 3/02

(52) U.S. Cl. 442/172; 442/59; 427/381

(57) ABSTRACT

A coated fabric suitable for use in an anti-ballistic article comprises a fabric comprising at least a first layer of high tenacity yarns such as para-aramid arranged parallel with each other and at least a second layer of high tenacity yarns arranged parallel with each other, the yarns of the first layer having an orientation in a direction that is different from the orientation of the yarns in the second layer, a fluoropolymer, a viscoelastic resin and a thermoset or thermoplastic binding layer, the binding layer being positioned between the first and second layers of yarns. A method of making the surfactant free coated fabric using a non-polar organic solvent is also disclosed.

### BACKGROUND OF THE INVENTION

1. Field of the Invention

This invention relates to an article for use in body armor and a method for making the article. The invention further provides a method of producing a ballistic resistant fabric.

2. Description of Related Art

PCT patent application WO 2008/121677 to Ardiff et al discloses a ballistic resistant fabric comprising a plurality of overlapping, cross-plied fiber plies, the fibers having a tenacity of about 7 g/denier or more and a tensile modulus of about 150 g/denier or more; the fibers having a fluorine-containing polymeric binder composition thereon; the plurality of overlapping cross-plied fiber plies being consolidated with the polymeric binder composition to form a single-layer, consolidated fabric. The disclosed fluoropolymers are either aqueous based long Rf (≧C8) materials or short side chain Rf based on a polyether backbone. The short side chain polyether materials, PolyFox™, are hydrocarbon polyether polyols with fluorinated side chains of controlled chain length.

United States patent application 2009/163105 to Ardiff and colleagues addresses ballistic resistant fabrics and articles that retain superior ballistic resistance performance after exposure to liquids such as sea water and organic solvents, such as gasoline and other petroleum-based products. The fabrics are formed from high performance fibers coated with a nitrile rubber binder polymer having an acrylonitrile content of from about 15 wt. % to about 50 wt. %, and are optionally coated with a binder that is a blend of a nitrile rubber and a fluorine-containing material.

U.S. Pat. No. 5,229,199 to Miner and Zahr teaches a rigid composite comprising a polyester, phenolic, or polyamide resin matrix reinforced with continuous p-aramid filaments coated with from about 0.2 to 5 percent, by weight, of a solid adhesion modifier, the coated filaments, when embedded in a polyester, phenolic, or polyamide resin matrix and tested in accordance with MIL-STD-662D exhibit a ballistics limit between about 1000 and 4000 feet per second and a composite areal density from about 0.4 to 6 pounds per square foot. The solid adhesion modifier is, preferably, a 2-perfluoroalkylethyl ester or paraffin wax or a combination of those materials. The composite, generally, comprises from about 50 to 90 percent, by weight, filaments and is, preferably, from about 60 to 85 percent, by weight, filaments.

U.S. Pat. No. 7,132,131 to Boettger et al discloses a method for producing a hydrophobically finished aramid fabric including applying a water-repellent agent to an aramid yarn, drying the aramid yarn, producing a fabric from the aramid yarn and heat treating the fabric. The fabric is used to produce an antiballistically effective article.

Brown and Meng, disclose in U.S. patent application Ser. No. 12/789,086, a fluoropolymer composition comprising a copolymer of fluoroalkyl (meth)acrylates and non-fluorinated (meth)acrylates in an organic solvent and its use as an additive to coating compositions such as alkyd paints or polymeric resins.

### SUMMARY OF THE INVENTION

This invention pertains to a method comprising, in order, the steps of

(a) coating and impregnating a fabric comprising at least a first layer of yarns arranged parallel with each other and at least a second layer of yarns arranged parallel with each other, a binding film positioned between the layers of yarns and a thread interlaced transversely within the layers to hold the layers together, the yarns of the at least a first layer having an orientation in a direction that is different from the orientation of the yarns of the at least a second layer, wherein the yarns have a linear density of from 50 to 4500 dtex, a tenacity of from 10 to 65 g/dtex, a modulus of from 150 to 2700 g/dtex, and an elongation to break of from 1 to 8 percent, with a coating solution wherein the solution comprises
(i) a fluoropolymer composition,
(ii) a viscoelastic resin, and
(iii) a non-polar organic solvent

(b) removing solvent to a level such that the remaining solvent is no greater than 0.5 percent by weight of the coated fabric weight, and

(c) consolidating the coated fabric under heat and pressure to further impregnate the coating into the yarn.

The fluoropolymer composition useful in the method of the present invention comprises a fluoropolymer and a solvent, wherein the fluoropolymer comprises repeating units in any sequence of the following:

[R_{f}—X—Y—C(O)—CZ—CH₂]ₐ— I:

[R_{f}—X—Y—C(O)—CH—CH₂]_{b}— II:

[CCl₂—CH₂]_{c}— III:

[R¹—O—C(O)—C(CH₃)—CH₂]_{d}— IV:

[R¹—O—C(O)—CH—CH₂]ₑ— V:

[R²—Y—C(O)—CT-CH₂]_{g} VI:

wherein

R_{f} is a straight or branched perfluoroalkyl group having 2-6 carbon atoms, which is optionally interrupted by at least one oxygen atom, or a mixture thereof of two or more thereof;

X is an organic divalent linking group having from 1 to 20 carbon atoms, optionally containing a triazole, oxygen, nitrogen, or sulfur, or a combination thereof;

Y is O, S or N(R) wherein R is H or C₁ to C₂₀ alkyl;

Z is a straight or branched alkyl group having from 1 to 4 carbon atoms, or halide;

R¹ is a straight or branched alkyl group having from 12 to 22 carbon atoms;

a is a positive integer;

b is a zero or positive integer;

c is a positive integer;

d is a positive integer;

e is a zero or positive integer;

g is zero or a positive integer;

T is H, a straight, branched or cyclic alkyl group having from 1 to 10 carbon atoms, or halide;

R² is H, CₙH₂ₙ₊₁, CₙH₂ₙ₋₁, CₘH₂ₘ—CH(O)CH₂, [CH₂CH₂O]ₚR³, [CH₂CH(CH₃)O]ₚR³, [CₘH₂ₘ]N(R³)₂;

n is from 8 to 40;

m is 1 to 40;

each R³ is independently H, CH₂OH or C_{q}H_{2q+1};

p is 1 to 200;

q is 0 to 40; and

provided that

1) repeating unit I, [R_{f}—X—Y—C(O)—CZ—CH₂]ₐ—, is present in the fluoropolymer at a minimum of 30% by weight of the fluoropolymer,

2) repeating units I, II and III, [R_{f}—X—Y—C(O)—CZ—CH₂]ₐ—, [R_{f}—X—Y—C(O)—CH—CH₂]_{b}— and [CCl₂—CH₂]_{c}— are present at a minimum combined total of 50% by weight of the fluoropolymer; and

3) the total of all repeating units, I-VI plus any optional monomers equals 100% by weight of the fluoropolymer.

The invention further pertains to a coated fabric suitable for use in an anti-ballistic article comprising:

(a) from 75.0 to 96.0 weight percent of a fabric comprising at least a first layer of yarns arranged parallel with each other and at least a second layer of yarns arranged parallel with each other, the yarns of the first layer having an orientation in a direction that is different from the orientation of the yarns in the second layer, wherein the yarns have a linear density of from 50 to 4500 dtex, a tenacity of from 10 to 65 g/dtex, a modulus of from 150 to 2700 g/dtex, and an elongation to break of from 1 to 8 percent,

(b) from 0.1 to 10.0 weight percent of a fluoropolymer composition,

(c) from 0.1 to 10.0 weight percent of a viscoelastic resin, and

(d) from 1.0 to 15.0 weight percent of a thermoset or thermoplastic binding layer positioned between the at least a first and the at least a second layers of yarns and a thread interlaced transversely within the layers to hold the layers together, wherein the relative weights are expressed as a weight percentage of the combined weight of fabric, fluoropolymer composition, viscoelastic resin and binding layer.

### BRIEF DESCRIPTION OF FIGURES

FIG. 1 shows a plan view in perspective of a composite used to produce a ballistic resistant armor article.

FIG. 2 shows a sectional view taken at 2-2 in FIG. 1.

FIG. 3 shows a sectional view of another embodiment comprising four nonwoven layers.

### DETAILED DESCRIPTION

The term “(meth)acrylates” used herein denotes either acrylates, methacrylates or both.

### Coated Fabric

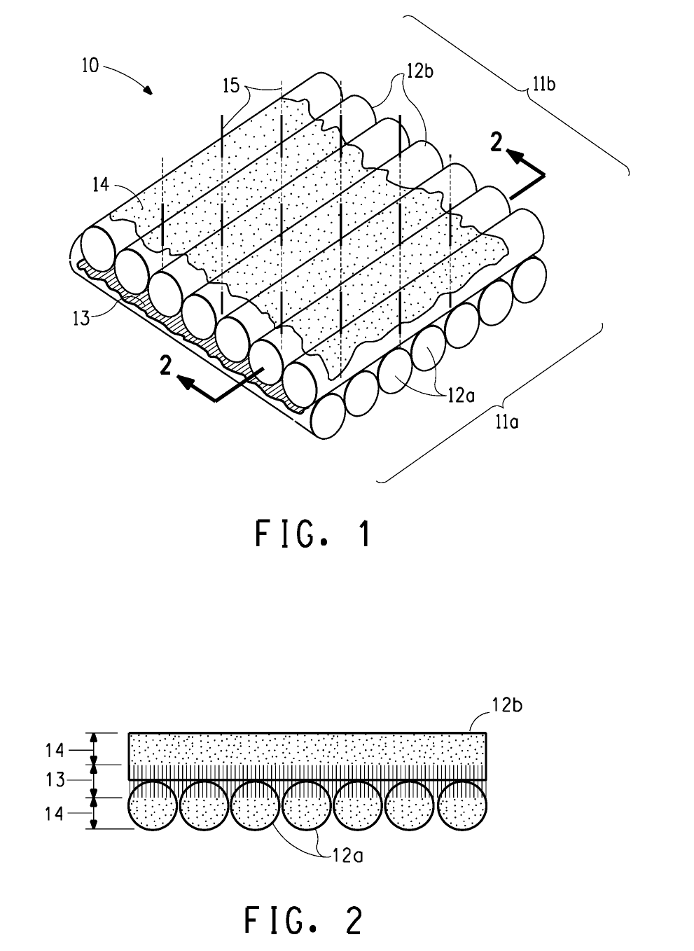

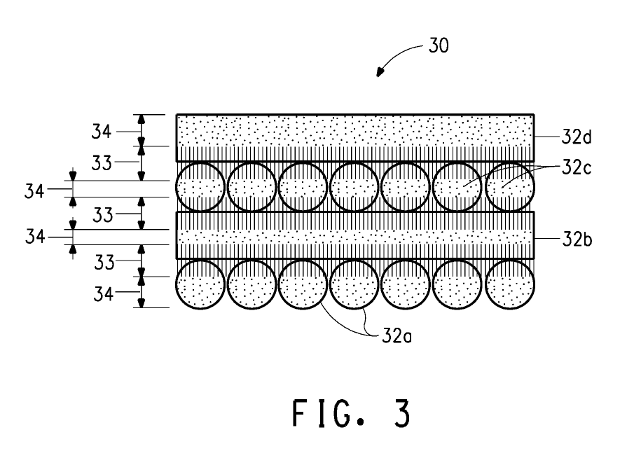

The coated fabric comprises a plurality of layers of unidirectional yarns. By unidirectional we mean that all the reinforcement yarns within a layer lie in the same direction. Such a layer is often referred to as a nonwoven layer. In a preferred embodiment the fabric comprises four layers and in a more preferred embodiment it comprises two layers. The orientation of yarns in one layer of the fabric is different from the orientation of the yarns in an adjacent layer. FIG. 1 shows generally at 10, a fabric comprising two nonwoven layers 11a and 11b of reinforcement yarns 12a and 12b. The orientation of the first plurality of yarns 12a in the first layer 11a of the fabric is different from the orientation of the second plurality of yarns 12b in the second layer 11b. As an example, the orientation of yarns in the first layer may be at zero degrees i.e. in the machine or run direction while the yarns in a second layer may be oriented at an angle of 90 degrees with respect to the orientation of yarns in the first layer. Other common orientation angles include +45 degrees and −45 degrees. In a preferred embodiment the yarns in successive layers of the nonwoven fabric are oriented at zero degrees and 90 degrees with respect to each other. FIG. 3 shows generally at 30a sectional view of a fabric comprising four nonwoven layers of reinforcement yarns. The orientation of yarns 32a and 32c in the first and third layers respectively are in the same direction. The orientation of yarns 32b and 32d in the second and fourth layers respectively are in the same direction. The orientation of the yarns in the first and third layers is orthogonal to the orientation of yarns in the second and fourth layers.

In a preferred embodiment, the fabric also contains a binding layer that is located between the yarn layers, preferably between all the yarn layers. Preferably the binding layer comprises a resin.

In addition to the resin binding layer, a thread is interlaced transversely within the layers to function as a binding thread and hold the layers together.

The yarns of the fabric are also coated with a matrix resin.

### Yarns

The nonwoven fabric layers comprise yarns having a plurality of filaments. The yarns can be intertwined and/or twisted. For purposes herein, the term “filament” is defined as a relatively flexible, macroscopically homogeneous body having a high ratio of length to width across its cross-sectional area perpendicular to its length. The filament cross section can be any shape, but is typically circular or bean shaped. Herein, the term “fiber” is used interchangeably with the term “filament”, The filaments can be any length. Preferably the filaments are continuous. Multifilament yarn spun onto a bobbin in a package contains a plurality of continuous filaments. The multifilament yarn can be cut into staple fibers and made into a spun staple yarn suitable for use in the present invention. The staple fiber can have a length of 1.5 to about 5 inches (about 3.8 cm to about 12.7 cm). The staple fiber can be straight (i.e., non-crimped) or crimped to have a saw tooth shaped crimp along its length, with a crimp (or repeating bend) frequency of 3.5 to 18 crimps per inch (about 1.4 to about 7.1 crimps per cm).

Preferably the yarns have a yarn tenacity of at least 7 grams per dtex and a modulus of at least 100 grams per dtex. Preferably, the yarns have a linear density of 50 to 4500 dtex, a tenacity of 10 to 65 g/dtex, a modulus of 150 to 2700 g/dtex, and an elongation to break of 1 to 8 percent. More preferably, the yarns have a linear density of 100 to 3500 dtex, a tenacity of 15 to 50 g/dtex, a modulus of 200 to 2200 g/dtex, and an elongation to break of 1.5 to 5 percent.

Suitable materials for the yarn include polyamide, polyolefin, polyazole and mixtures thereof.

When the polymer is polyamide, aramid is preferred. The term “aramid” means a polyamide wherein at least 85% of the amide (—CONH—) linkages are attached directly to two aromatic rings. Suitable aramid fibers are described in Man-Made Fibres—Science and Technology, Volume 2, Section titled Fibre-Forming Aromatic Polyamides, page 297, W. Black et al., Interscience Publishers, 1968.

A preferred aramid is a para-aramid. A preferred para-aramid is poly(p-phenylene terephthalamide) which is called PPD-T. By PPD-T is meant a homopolymer resulting from mole-for-mole polymerization of p-phenylene diamine and terephthaloyl chloride and, also, copolymers resulting from incorporation of small amounts of other diamines with the p-phenylene diamine and of small amounts of other diacid chlorides with the terephthaloyl chloride. As a general rule, other diamines and other diacid chlorides can be used in amounts up to as much as 10 mole percent of the p-phenylene diamine or the terephthaloyl chloride, or perhaps slightly higher, provided only that the other diamines and diacid chlorides have no reactive groups which interfere with the polymerization reaction. PPD-T, also, means copolymers resulting from incorporation of other aromatic diamines and other aromatic diacid chlorides such as, for example, 2,6-naphthaloyl chloride or chloro- or dichloroterephthaloyl chloride or 3,4′-diaminodiphenylether.

Additives can be used with the aramid and it has been found that up to as much as 10 percent or more, by weight, of other polymeric material can be blended with the aramid. Copolymers can be used having as much as 10 percent or more of other diamine substituted for the diamine of the aramid or as much as 10 percent or more of other diacid chloride substituted for the diacid chloride or the aramid.

When the polymer is polyolefin, polyethylene or polypropylene is preferred. The term “polyethylene” means a predominantly linear polyethylene material of preferably more than one million molecular weight that may contain minor amounts of chain branching or comonomers not exceeding 5 modifying units per 100 main chain carbon atoms, and that may also contain admixed therewith not more than 50 weight percent of one or more polymeric additives such as alkene-1-polymers, in particular low density polyethylene, propylene, and the like, or low molecular weight additives such as anti-oxidants, lubricants, ultra-violet screening agents, colorants and the like which are commonly incorporated. Such is commonly known as extended chain polyethylene (ECPE) or ultra high molecular weight polyethylene (UHMWPE

In some preferred embodiments polyazoles are polyarenazoles such as polybenzazoles and polypyridazoles. Suitable polyazoles include homopolymers and, also, copolymers. Additives can be used with the polyazoles and up to as much as 10 percent, by weight, of other polymeric material can be blended with the polyazoles. Also copolymers can be used having as much as 10 percent or more of other monomer substituted for a monomer of the polyazoles. Suitable polyazole homopolymers and copolymers can be made by known procedures.

Preferred polybenzazoles are polybenzimidazoles, polybenzothiazoles, and polybenzoxazoles and more preferably such polymers that can form fibers having yarn tenacities of 30 gpd or greater. If the polybenzazole is a polybenzothioazole, preferably it is poly(p-phenylene benzobisthiazole). If the polybenzazole is a polybenzoxazole, preferably it is poly(p-phenylene benzobisoxazole) and more preferably poly(p-phenylene-2,6-benzobisoxazole) called PBO.

Preferred polypyridazoles are polypyridimidazoles, polypyridothiazoles, and polypyridoxazoles and more preferably such polymers that can form fibers having yarn tenacities of 30 gpd or greater. In some embodiments, the preferred polypyridazole is a polypyridobisazole. A preferred poly(pyridobisozazole) is poly(1,4-(2,5-dihydroxy)phenylene-2,6-pyrido[2,3-d:5,6-d′]bisimidazole which is called PIPD. Suitable polypyridazoles, including polypyridobisazoles, can be made by known procedures.

The yarns within a nonwoven layer of the fabric may comprise yarns from different polymers. In an alternative embodiment the fabric may comprise layers having different polymeric yarns in different layers but all the yarns within a layer being from the same polymer.

In preferred embodiments there is a resin binding layer between the nonwoven fabric layers of the fabric to keep the nonwoven layers together and stop them sliding over one another.

### Binding Layer

The binder layer is shown at 13 in FIGS. 1 and 2 and at 33 in FIG. 3. The binding layer of the fabric may be a thermoset or thermoplastic material. The binding layer may be in a continuous form such as a film or discontinuous form such as a perforated film or a powder. Suitable materials for this binding layer include thermoplastic polyolefinic films, thermoplastic elastomeric films, polyester films, polyamide films, polyurethane films and mixtures thereof. Useful thermoplastic polyolefinic films include low density polyethylene films, high density polyethylene films and linear low density polyethylene films. The binding layer does not fully impregnate into the yarns. Preferably the binding layer is present in the fabric in an amount from 1.0 to 15.0 weight percent based on the total weight of yarn plus binding layer and matrix resin ingredients.

### Binding Thread

The binding thread is knitted through the nonwoven layers of the fabric. The binding threads go all the way through the fabric from one outer surface of the fabric to the other outer surface. These binding threads, shown at 15 in FIG. 1, are stitched or knitted through the nonwoven layers in a direction orthogonal to the plane of the layers. Any suitable knitting thread may be used as a binder thread with polyester, polyamide, polyethylene or polyareneazole being particularly suited, Examples of polyamide include aramid and nylon. Para-aramid is a suitable aramid. Examples of polyarenazole include polypyridazole and polypyridobisimidazole.

### Matrix Resin Coating Solution

The yarns of the fabric are coated with a resin solution comprising a fluoropolymer composition, a viscoelastic resin and a non-polar organic solvent. This resin is shown at 14 in FIGS. 1 and 2 and at 34 in FIG. 3. Preferably the fluoropolymer composition is present in the coated fabric in an amount from 0.1 to 10.0 weight percent and more preferably from 0.3 to 5.0 weight percent based on the total weight of yarn plus binding layer and matrix resin ingredients.

The fluoropolymer is a short chain fluorinated (meth)acrylate (C2 to C6) based polymer that does not contain oxygen in the polymer backbone

Suitable fluoropolymer compositions include polymers based on perfluorourethane, fluorosiloxane, perfluoroalkyl, perfluoroether, vinylidene chloride or mixtures thereof. Examples of perfluoroalkyls are perfluoroalkyl methacrylates, perfluoroalkyl acrylates, and perfluoroalkyl urethanes. An example of fluorosiloxane is fluoroalkyl siloxane urethane. An example of perfluoroether is perfluoroether urethane.

Preferably, the fluoropolymer composition useful in the method of the present invention comprises a fluoropolymer and a solvent, wherein the fluoropolymer comprises repeating units in any sequence of the following:

[R_{f}—X—Y—C(O)—CZ—CH₂]ₐ— I:

[R_{f}—X—Y—C(O)—CH—CH₂]_{b}— II:

[CCl₂—CH₂]_{c}— III:

[R¹—O—C(O)—C(CH₃)—CH₂]_{d}— IV:

[R¹—O—C(O)—CH—CH₂]ₑ— V:

[R²—Y—C(O)—CT-CH₂]_{g}— VI:

wherein

R_{f} is a straight or branched perfluoroalkyl group having 2-6 carbon atoms, which is optionally interrupted by at least one oxygen atom, or a mixture thereof of two or more thereof;

X is an organic divalent linking group having from about 1 to 20 carbon atoms, optionally containing a triazole, oxygen, nitrogen, or sulfur, or a combination thereof;

Y is O, S or N(R) wherein R is H or C₁ to C₂₀ alkyl;

Z is a straight or branched alkyl group having from 1 to about 4 carbon atoms, or halide;

R¹ is a straight or branched alkyl group having from 12 to 22 carbon atoms;

a is a positive integer;

b is a zero or positive integer;

c is a positive integer;

d is a positive integer;

e is a zero or positive integer;

g is zero or a positive integer;

T is H, a straight, branched or cyclic alkyl group having from 1 to about 10 carbon atoms, or halide;

R² is H, CₙH₂ₙ₊₁, CₙH₂ₙ₋₁, CₘH₂ₘ—CH(O)CH₂, [CH₂CH₂O]ₚR³, [CH₂CH(CH₃)O]ₚR³, [CₘH₂ₘ]N(R³)₂;

n is from 8 to 40;

m is 1 to 40;

each R³ is independently H, CH₂OH or C_{q}H_{2q+1};

p is 1 to 200;

q is 0 to 40; and

provided that

1) repeating unit I, [R_{f}—X—Y—C(O)—CZ—CH₂]ₐ—, is present in the fluoropolymer at a minimum of 30% by weight of the fluoropolymer,

2) repeating units I, II and III, [R_{f}—X—Y—C(O)—CZ—CH₂]ₐ—, [R_{f}—X—Y—C(O)—CH—CH₂]_{b}— and [CCl₂—CH₂]_{c}— are present at a minimum combined total of 50% by weight of the fluoropolymer; and

3) the total of all repeating units, I-VI plus any optional monomers equals 100% by weight of the fluoropolymer.

The fluoropolymer composition comprises repeating units I-VI, as defined above, in any sequence. The fluoropolymer may be a random copolymer, statistical copolymer, block copolymer, multiblock copolymer, gradient copolymer, or alternating copolymer.

In units I and II, the Formula, R_{f} is preferably a straight or branched perfluoroalkyl group having 2-6 carbon atoms, which is optionally interrupted by at least one oxygen atom, or a mixture of the straight or branched perfluoroalkyl groups having 6 carbon atoms. More preferably R_{f} is a straight or branched C₆F₁₃—.

The subscripts a, c, and d are each independently a positive integer, preferably from 1 to 10,000, more preferably from 5 to 2000. The subscripts b, e, and g are each independently zero or a positive integer, preferably from 0 to 10,000, more preferably from about 0 to 2000.

Examples of suitable linking groups X in units I and II include straight chain, branched chain or cyclic structures of alkylene, arylene, aralkylene, sulfonyl, sulfoxy, sulfonamido, carbonamido, carbonyloxy, urethanylene, ureylene, and combinations of such linking groups such as sulfonamidoalkylene.

Examples of groups Y in units I, II and VI are O, S or N(R) wherein R is H or C₁ to C₂₀ alkyl. Preferably R is H or C₁ to O₄ alkyl.

Z is a straight or branched chain alkyl group having from 1 to 4 carbon atoms or Z is a halide. Useful halides are fluoride, chloride and iodide.

Fluorinated (meth)acrylate monomers suitable for use in this invention to provide unit I have the general formula R_{f}—X—Y—C(O)—C(Z)═CH₂, wherein R_{f}, X, Y and Z are defined herein. Similarly, fluorinated (meth)acrylate monomers suitable for use in this invention to provide unit II have the general formula R_{f}—X—Y—C(O)—CH)═CH₂, wherein R_{f}, X, and Y are defined herein.

R¹ is a straight or branched alkyl group having from 12 to 22 carbon atoms. Preferably R¹ is stearyl (octadecyl), CH₃(CH₂)₁₇. Specific alkyl (meth)acrylate monomers useful to provide units III and IV include include stearyl (meth)acrylate, tridecyl (meth)acrylate, and lauryl (meth)acrylate, wherein stearyl (meth)acrylate is preferred.

Nonfluorinated (meth)acrylate monomers suitable for the use in the present invention to provide unit VI include one or more alkyl (meth)acrylates wherein the alkyl group, R², for each alkyl (meth)acrylate is independently a straight or branched chain containing 8 to 40 carbon atoms. Two or more alkyl (meth)acrylates can be used. Preferably the alkyl group in the alkyl (meth)acrylate contains 8 to 20 carbon atoms. The alkyl(meth)acrylate can be linear or branched. Examples of suitable alkyl(meth)acrylates include, but are not limited to, alkyl(meth)acrylates wherein the alkyl group is octyl, 2-ethylhexyl, decyl, isodecyl, lauryl, cetyl, or stearyl. Preferred alkyl (meth)acrylates to provide unit VI are 2-ethylhexyl acrylate, lauryl acrylate and stearyl acrylate.

Other nonfluorinated (meth)acrylate monomers suitable for the use in the present invention to provide unit VI include one or more of the following: N-methylol (meth)acrylates, hydroxyalkyl (meth)acrylates, alkyloxy(meth)acrylates, glycidyl (meth)acrylates, stearyl acrylate, aminoalkyl methacrylate hydrochloride, acrylamide, and alkyl acrylamide. N-Methylol monomers include, but are not limited to N-methylolacrylamide and N-methylolmethacrylamide. Suitable hydroxyalkyl (meth)acrylates have alkyl chain lengths of 2 to 4 carbon atoms, and include 2-hydroxyethyl acrylate and 2-hydroxyethyl methacrylate. Suitable alkyloxy(meth)acrylates have alkyl chain lengths of 2 to 4 carbon atoms, and contain between 1 and 12 oxyalkylene units per molecule, preferably from 4 and 10 oxyalkylene units per molecule, and most preferably from 6 and 8 oxyalkylene units per molecule.

Suitable optional monomers for use in the preparation of the fluoropolymer described herein include vinyl acetate, vinyl stearate, alkyl vinyl sulfone, styrene, vinyl benzoic acid, alkyl vinyl ether, maleic anhydride, vinyl chloride, and olefins.

The viscoelastic resin may be thermoplastic or thermoset. Suitable materials include polymers or resins in the form of a viscous or viscoelastic liquid. Preferred materials are polyolefins, in particular polyalpha-olefins or modified polyolefins, polyvinyl alcohol derivatives, polyisoprenes, polybutadienes, polybutenes, polyisobutylenes, polyesters, polyacrylates, polyamides, polysulfones, polysulfides, polyurethanes, polycarbonates, polyfluoro-carbons, silicones, glycols, liquid block copolymers, polystyrene-polybutadiene-polystyrene, ethylene co-polypropylene, polyacrylics, epoxies, phenolics and liquid rubbers. Preferred polyolefins are polyethylene and polypropylene. Preferred glycols are polypropylene glycol and polyethylene glycol. A preferred copolymer is polybutadiene-co-acrylonitrile. Polyisobutylene is a preferred resin. In a preferred embodiment, the resin coating does not fully impregnate the yarns. Preferably the visco-elastic resin is present in the coated fabric in an amount from 0.1 to 10.0 weight percent and more preferably from 4.0 to 8.0 weight percent based on the total weight of yarn plus binding layer and matrix resin ingredients.

The solvent may be aliphatic, aromatic, cyclic or based on halogenated hydrocarbons. More preferably the solvent is a non-polar organic solvent. Examples of suitable solvents consist of methyl isobutyl ketone, butyl acetate, tetrahydrofuran, acetone, isopropanol, ethyl acetate, methylene chloride, chloroform, carbon tetrachloride, cyclohexane, hexane, dioxane, hexafluoroisopropanol, and mixtures of two or more thereof. Preferred non-polar organic solvents include n-heptane and cyclohexane.

Water based water based acrylic resin binders are not desirable for use in this composition as the acrylic material will come out of solution in the organic solvent.

Surfactant is not required with the above fluoropolymer compositions to achieve a uniform coating on the yarns, that is the compositions are surfactant free.

### Coating Method

A method for providing a ballistic resistant fabric sheet comprises, in order, the steps of

(a) coating and impregnating a fabric comprising at least a first layer of yarns arranged parallel with each other and at least a second layer of yarns arranged parallel with each other, a binding film positioned between the layers of yarns and a binding thread interlaced transversely with the layers to hold layers together, the yarns of the first layer having an orientation in a direction that is different from the orientation of the yarns in the second layer, wherein the yarns have a linear density of from 50 to 4500 dtex, a tenacity of from 10 to 65 g/dtex, a modulus of from 150 to 2700 g/dtex, and an elongation to break of from 1 to 8 percent, with a coating solution wherein the coating solution comprises
(j) a fluoropolymer composition,
(ii) a viscoelastic resin, and
(iii) a non-polar organic solvent

(b) removing solvent to a level such that the remaining solvent is no greater than 0.5 percent by weight of the coated fabric weight, and

(c) consolidating the coated fabric under heat and pressure to further impregnate the coating into the yarn.

The fabric may be coated by immersion in a resin solution bath followed by metering off the desired amount of resin using metering rolls and then removing solvent in an oven. An alternative method is to coat the desired amount resin solution onto the surface of the fabric by a method such as knife over roll coating followed by solvent removal. These and other suitable processes are well known in the materials coating industries. Preferably the residual solvent in the coated fabric is no greater than 0.5 percent, more preferably no greater than 0.3 percent and most preferably no greater than 0.1 percent. The solvent comprises from 50 to 95 weight percent of the coating solution. The dried coated fabric is then further consolidated under heat and pressure to further impregnate the coating into the yarns. This may be achieved via a calendering or similar process. The specific values for heat and pressure need to be determined for each material combination. Typically, the temperature is in the range of from 90 to 300 degrees C., preferably from 100 to 200 degrees C. and the pressure in the range of from 1 to 100 bar, preferably from 5 to 80 bar.

### Anti-Ballistic Article

The nonwoven fabric of this invention may be used in an article to provide resistance against a ballistic threat. The number of sheets of fabric used in the article will depend on the targeted threat but typically is between five and twenty. The position of the sheets in the article will also depend on the article design. Other components such as foam may also be incorporated into the article. The article is particularly useful for soft body armor.

### Test Methods

The following test methods were used in the following Examples.

Linear Density: The linear density of a yarn or fiber is determined by weighing a known length of the yarn or fiber based on the procedures described in ASTM D1907-97 and D885-98. Decitex or “dtex” is defined as the weight, in grams, of 10,000 meters of the yarn or fiber. Denier (d) is 9/10 times the decitex (dtex).

Tensile Properties: The fibers to be tested were conditioned and then tensile tested based on the procedures described in ASTM D885-98. Tenacity (breaking tenacity), modulus of elasticity and elongation to break are determined by breaking test fibers on an Instron® universal test machine.

Areal Density: The areal density of the fabric layer is determined by measuring the weight of each single layer of selected size, e.g., 10 cm×10 cm. The areal density of a composite structure is determined by the sum of the areal densities of the individual layers.

Ballistic Penetration and Backface Deformation Performance: Ballistic tests of the multi-sheet panels were conducted in accordance with NIJ Standard—0101.04 “Ballistic Resistance of Personal Body Armor”, issued in September 2000 which defines capabilities for body armor for level IIIA protection. The armor must have a Backface Deformation (BFD) of no more than of 44 mm from a 0.44 magnum bullet at a velocity (Vₒ) defined as 1430 ft/sec plus or minus (+/−) 30 feet per sec (436 m/sec +/−9 m/sec). A second reported value is V50 which is a statistical measure that identifies the average velocity at which a bullet or a fragment penetrates the armor equipment in 50% of the shots, versus non penetration of the other 50%. The parameter measured is V50 at zero degrees where the degree angle refers to the obliquity of the projectile to the target. The reported values are average values for the number of shots fired for each example. A 0.44 magnum bullet was used.

Water repellency of the fabric was measured according to the DuPont Technical Laboratory Method as further detailed on page 2 of the TEFLON Global Specifications and Quality Control Tests information brochure which is available from DuPont. This test is based on AATCC TM193. The test determines the resistance of the fabric to wetting by aqueous liquids. Drops of water-alcohol mixtures of varying surface tensions are placed on the fabric and the extent of surface wetting is determined visually. The test provides an index of aqueous stain resistance. The higher the water repellency rating, the better the resistance the finished substrate has to staining by water-based substances. The composition of the standard test liquids used is shown in Table 1. A zero water repellency rating indicates complete substrate wetting by 100% distilled water.

TABLE 1

| Water Repellency | Volume % | Volume % |
|---|---|---|
| Rating | Isopropyl Alcohol | Distilled Water |
| 1 | 2 | 98 |
| 2 | 5 | 95 |
| 3 | 10 | 90 |
| 4 | 20 | 80 |
| 5 | 30 | 70 |
| 6 | 40 | 60 |

### EXAMPLES

The following examples are given to illustrate the invention and should not be interpreted as limiting it in any way.

In all the Examples and Comparative Example the nonwoven fabric used was Kevlar® XP™ S102 available from E.I. DuPont, Wilmington, Del. This fabric comprises two layers of unidirectionally aligned para-aramid yarns in a +45°/−45° configuration with a binding layer in between. The fabric sheet has a nominal weight of 500 g/m². The yarn used in the fabric construction is Kevlar® 129, also available from DuPont. The yarn has a nominal tenacity of 24.5 g/dtex, a nominal modulus of 680 g/dtex, and a nominal elongation to break of 3.4 percent. Yarn of 83 dtex polyester is used as binding thread to interlace transversely within the layers to hold the layers together. Kevlar® XP fabric also comprises a binding film and a viscoelastic resin.

### Comparative Example 1

Ten sheets of Kevlar® XP™ S102 fabric were held together by stitches located at the four corners of the sheets (corner stitch) The corner stitching thread was Tex 70 spun Kevlar® available from Saunders Thread Company, Gastonia, N.C. A layer of 3 mm thick polyethylene foam having an areal weight of 100 g/m² was placed at the back of the fabric assembly that is. the foam is facing away from the strike direction. The total weight of fabric plus foam was 5.1 kg/m². Ballistic testing was conducted using 0.44 magnum bullets against targets supported on a Roma Plastina number 1 clay backing medium. Results of the ballistic tests gave an average V50 value of 488 m/s and an average Back Face Deflection (BFD) value of 34 mm.

### Example 1

This example was made in a similar way to Comparative Example 1 except that a fluoropolymer composition, as defined above, was added to the viscoelastic resin coating solution used to coat the fabric. The amount of fluoropolymer composition was about 2 weight percent based on the total weight of the treated nonwoven fabric (fabric yarns plus binder layer plus viscoelastic resin plus methacrylate polymer). The fluoropolymer composition treated fabric sheet had a weight of 510 g/m². The assembly of ten sheets of XP fabric plus PE foam had a total basis weight of 5.2 kg/m². Results of the ballistic tests gave an average V50 value of 490 m/s and an average Back Face Deflection value of 32 mm.

### Example 2

This example was made in a similar way to Example 1 except that the amount of fluoropolymer composition added was about 4 weight percent based on the total weight of the treated nonwoven fabric. The methacrylate treated fabric sheet had a nominal weight of 520 g/m². The assembly of ten sheets of XP fabric plus PE foam had a total basis weight of 5.3 kg/m². Results of the ballistic tests gave an average V50 value of 506 m/s and an average Back Face Deflection value of 34 mm.

### Water Repellency Testing

A single sheet of XP fabric according to the above examples was tested for water repellency. The results, as shown in Table 2, demonstrate that the addition of perfluoropolymer to the viscoelastic coating resin significantly improved water repellency of the fabric.

### Ballistic Testing

The results are shown in Table 2 and show that Examples 1 and 2 have about the same Back Face Deflection and about equivalent or better V50 performance when compared with Comparative Example 1. That is to say that the water repellent treatment did not result in any negative impact on the ballistic performance of Examples 1 and 2.

TABLE 2

| | Areal Density | V50 | BFD | Water Repellant |
|---|---|---|---|---|
| Reference | (kg per sq. m.) | (m/sec) | (mm) | Rating |
| Example 1 | 5.2 | 490 | 32 | 6 |
| Example 2 | 5.3 | 506 | 34 | 6 |
| Comparative 1 | 5.1 | 488 | 34 | 3 |

What is claimed is:

1. A method comprising, in order, the steps of
(a) coating and impregnating a fabric comprising at least a first layer of yarns arranged parallel with each other and at least a second layer of yarns arranged parallel with each other, a binding film positioned between the layers of yarns and a binding thread interlaced transversely with the layers to hold layers together, the yarns of the at least a first layer having an orientation in a direction that is different from the orientation of the yarns of the at least a second layer, wherein the yarns have a linear density of from 50 to 4500 dtex, a tenacity of from 10 to 65 g/dtex, a modulus of from 150 to 2700 g/dtex, and an elongation to break of from 1 to 8 percent, with a surfactant free coating solution wherein the solution comprises
(i) a fluoropolymer composition,
(ii) a viscoelastic resin, and
(iii) a non-polar organic solvent
(b) removing solvent to a level such that the remaining solvent is no greater than 0.5 percent by weight of the coated fabric weight, and
(c) consolidating the coated fabric under heat and pressure to further impregnate the coating into the yarn.

2. A method of claim 1, wherein the fluoropolymer composition comprises a fluoropolymer and a solvent, wherein the fluoropolymer comprises repeating units in any sequence of the following:
[R_{f}—X—Y—C(O)—CZ—CH₂]ₐ— I:
[R_{f}—X—Y—C(O)—CH—CH₂]_{b}— II:
[CCl₂—CH₂]_{c}— III:
[R¹—O—C(O)—C(CH₃)—CH₂]_{d}— IV:
[R¹—O—C(O)—CH—CH₂]ₑ— V:
[R²—Y—C(O)—CT-CH₂]_{g} VI:
wherein
R_{f} is a straight or branched perfluoroalkyl group having 2-6 carbon atoms, which is optionally interrupted by at least one oxygen atom, or a mixture thereof of two or more thereof;
X is an organic divalent linking group having from 1 to 20 carbon atoms, optionally containing a triazole, oxygen, nitrogen, or sulfur, or a combination thereof;
Y is O, S or N(R) wherein R is H or C₁ to C₂₀ alkyl;
Z is a straight or branched alkyl group having from 1 to 4 carbon atoms, or halide;
R¹ is a straight or branched alkyl group having from 12 to 22 carbon atoms;
a is a positive integer;
b is a zero or positive integer;
c is a positive integer;
d is a positive integer;
e is a zero or positive integer;
g is zero or a positive integer;
T is H, a straight, branched or cyclic alkyl group having from 1 to 10 carbon atoms, or halide;
R² is H, CₙH₂ₙ₊₁, CₙH₂ₙ₋₁, CₘH₂ₘ—CH(O)CH₂, [CH₂CH₂O]ₚR³, [CH₂CH(CH₃)O]ₚR³, [CₘH₂ₘ]N(R³)₂;
n is from 8 to 40;
m is 1 to 40;
each R³ is independently H, CH₂OH or C_{q}H_{2q+1};
p is 1 to 200;
q is 0 to 40; and
provided that
1) repeating unit I, [R_{f}—X—Y—C(O)—CZ—CH₂]ₐ—, is present in the fluoropolymer at a minimum of 30% by weight of the fluoropolymer,
2) repeating units I, II and III, [R_{f}—X—Y—C(O)—CZ—CH₂]ₐ—, [R_{f}—X—Y—C(O)—CH—CH₂]_{b}— and [CCl₂—CH₂]_{c}— are present at a minimum combined total of 50% by weight of the fluoropolymer; and
3) the total of all repeating units, I-VI plus any optional monomers equals 100% by weight of the fluoropolymer.

3. The method of claim 1, wherein the yarns comprising the layers are made of filaments made from a polymer selected from the group consisting of polyamides, polyolefins, polyazoles, and mixtures thereof.

4. The method of claim 1, wherein the viscoelastic resin is polyolefin, polyvinyl alcohol, polyisoprene, polybutadiene, polybutene, polyisobutylene, polyester, polyacrylate, polyamide, polysulfone, polysulfide; polyurethane, polycarbonate, polyfluoro-carbon, silicone, glycol, liquid block copolymer, polyacrylic, epoxy, phenolic, liquid rubber or mixtures thereof.

5. The method of claim 1 wherein the binding thread comprises fiber of polyester, polyethylene, polyamide or polyareneazole.

6. The method of claim 1, wherein the solvent is non-polar.

7. The method of claim 3, wherein the polyamide yarn is p-aramid.

8. The method of claim 4, wherein the resin is polyisobutylene, polybutene or mixtures thereof.

9. A coated fabric suitable for use in an anti-ballistic article comprising:
(a) from 75.0 to 96.0 weight percent of a fabric comprising at least a first layer of yarns arranged parallel with each other and at least a second layer of yarns arranged parallel with each other, the yarns of the first layer having an orientation in a direction that is different from the orientation of the yarns in the second layer, wherein the yarns have a linear density of from 50 to 4500 dtex, a tenacity of from 10 to 65 g/dtex, a modulus of from 150 to 2700 g/dtex, and an elongation to break of from 1 to 8 percent,
(b) from 0.1 to 10.0 weight percent of a surfactant free fluoropolymer composition,
(c) from 0.1 to 10.0 weight percent of a viscoelastic resin, and
(d) from 1.0 to 15.0 weight percent of a thermoset or thermoplastic binding layer positioned between the at least a first and the at least a second layers of yarns and
(e) a binding thread interlaced transversely within the layers to hold the layers together,
wherein the relative weights are expressed as a weight percentage of the combined weight of fabric, fluoropolymer composition, viscoelastic resin, binding layer and binding thread.

10. The fabric of claim 9 wherein the fluoropolymer composition comprises a fluoropolymer and a solvent, wherein the fluoropolymer comprises repeating units in any sequence of the following:
[R_{f}—X—Y—C(O)—CZ—CH₂]ₐ— I:
[R_{f}—X—Y—C(O)—CH—CH₂]_{b}— II:
[CCl₂—CH₂]_{c}— III:
[R¹—O—C(O)—C(CH₃)—CH₂]_{d}— IV:
[R¹—O—C(O)—CH—CH₂]ₑ— V:
[R²—Y—C(O)—CT-CH₂]_{g} VI:
wherein
R_{f} is a straight or branched perfluoroalkyl group having 2-6 carbon atoms, which is optionally interrupted by at least one oxygen atom, or a mixture thereof of two or more thereof;
X is an organic divalent linking group having from 1 to 20 carbon atoms, optionally containing a triazole, oxygen, nitrogen, or sulfur, or a combination thereof;
Y is O, S or N(R) wherein R is H or C₁ to C₂₀ alkyl;
Z is a straight or branched alkyl group having from 1 to 4 carbon atoms, or halide;
R¹ is a straight or branched alkyl group having from 12 to 22 carbon atoms;
a is a positive integer;
b is a zero or positive integer;
c is a positive integer;
d is a positive integer;
e is a zero or positive integer;
g is zero or a positive integer;
T is H, a straight, branched or cyclic alkyl group having from 1 to 10 carbon atoms, or halide;
R² is H, CₙH₂ₙ₊₁, CₙH₂ₙ₋₁, CₘH₂ₘ—CH(O)CH₂, [CH₂CH₂O]ₚR³, [CH₂CH(CH₃)O]ₚR³, [CₘH₂ₘ]N(R³)₂;
n is from 8 to 40;
m is 1 to 40;
each R³ is independently H, CH₂OH or C_{q}H_{2q+}1;
p is 1 to 200;
q is 0 to 40; and
provided that
1) repeating unit I, [R_{f}—X—Y—C(O)—CZ—CH₂]ₐ—, is present in the fluoropolymer at a minimum of 30% by weight of the fluoropolymer,
2) repeating units I, II and III, [R_{f}—X—Y—C(O)—CZ—CH₂]ₐ—, [R_{f}—X—Y—C(O)—CH—CH₂]_{b}— and [CCl₂—CH₂]_{c}— are present at a minimum combined total of 50% by weight of the fluoropolymer; and
3) the total of all repeating units, I-VI plus any optional monomers equals 100% by weight of the fluoropolymer.

11. The fabric of claim 9 wherein the yarns of the layers are made of filaments made from a polymer selected from the group consisting of polyamides, polyolefins, polyazoles, and mixtures thereof.

12. The fabric of claim 9 wherein the viscoelastic resin is polyolefin, polyvinyl alcohol, polyisoprene, polybutadiene, polybutene, polyisobutylene, polyester, polyacrylate, polyamide, polysulfone, polysulfide; polyurethane, polycarbonate, polyfluorocarbon, silicone, glycol, liquid block copolymer, polyacrylic, epoxy, phenolic, liquid rubber or mixtures thereof.

13. The fabric of claim 10, wherein the polyamide yarn is para-aramid.

14. The fabric of claim 11, wherein the resin is polyisobutylene, polybutene or mixtures thereof.

15. An anti-ballistic article comprising the fabric of claim 7.
